(19) United States
(12) Patent Application Publication
(10) Pub. No.: US 2024/0139859 A1
(43) Pub. Date: May 2, 2024

(54) JOINING OF HIGH WEAR RESISTANT AND BASE MATERIALS

(71) Applicant: National Research Council of Canada, Ottawa (CA)

(72) Inventors: Jiaren Jiang, Surrey (CA); Oscar Alexander Zambrano, Vancouver (CA); Priti Wanjara, Pointe-Claire (CA); Javad Gholipour, Dollard-des-Ormeaux (CA)

(21) Appl. No.: 18/384,406

(22) Filed: Oct. 27, 2023

Related U.S. Application Data
(60) Provisional application No. 63/419,839, filed on Oct. 27, 2022.

(51) Int. Cl. B23K 20/12; B32B 15/01; B32B 15/18

(52) U.S. Cl. CPC B23K 20/1205; B32B 15/013; B32B 15/18; B23K 2103/04

(57) ABSTRACT

Linear friction welding is used to join dissimilar materials, namely a first workpiece formed of a high wear resistant material and a second workpiece formed of a base material. A compressive force is applied and a friction force is generated between the first and second workpieces. A solid-state joint is formed between the first and second workpieces. The high wear resistant material can be a tool steel, and the base material can be a low alloy steel or a carbon steel. The composite assemblies can be used for mining wear applications.

### CROSS-REFERENCE TO RELATED APPLICATION

This application claims priority to U.S. Provisional Application No. 63/419,839 filed Oct. 27, 2022, the entire contents of which are hereby incorporated herein by reference.

### FIELD

The present disclosure relates generally to metallurgy and the joining of dissimilar materials.

### INTRODUCTION

The following paragraphs are not an admission that anything discussed in them is prior art or part of the knowledge of persons skilled in the art.

Wear can be a significant cost factor in the mining industry due to rapid material loss and production interruptions. Materials having good wear resistance in mining applications can be hard and brittle and, as a result, may not have the mechanical strength and toughness required to withstand high working load for prolonged times. One strategy to meet the conflicting requirements is to apply a high wear resistant material on a strong and tough steel base, as a localized reinforcement to form a composite assembly.

Hardfacing is one such technique, e.g., applying weld overlays using laser or arc welding processes. However, for many heavy wear components, such as ground engaging tools (GET), the effectiveness of welding overlay is limited because the thickness of the overlay that can be applied by the weld deposition technologies (˜6 mm) is much less than the thickness of materials to be consumed (˜25 mm) before the end-of-life of the wear component. Preferably, the volume of the applied high wear-resistant material can be equal to or greater than the actual wear volume.

One method of attaching a higher volume of wear-resistant materials is brazing, such as brazing high chromium white cast iron blocks or cemented tungsten carbide tiles on a steel base. However, brazing involves high heat input to the whole assembly and the heat cycles tend to weaken the mechanical properties of the base/substrate materials. Thus, this brazing method is mainly used to produce wear blocks for use where these blocks are further supported by other structural backing, such as being welded or bolted onto the walls of chutes. Notwithstanding this purpose, the brazing method is generally not suited for protecting components under high working loads that require both high strength and toughness.

Linear friction welding (LFW) is a solid-state material joining technique that involves heat generation through mechanical friction between the contacting interfaces of two workpieces that are moving/reciprocating linearly relative to one another, while under an applied compressive force. Unlike conventional fusion welding, no melting of the workpiece materials occurs during LFW, which can provide advantages for joining difficult-to-weld materials, such as reactive titanium alloys and crack-sensitive nickel-based superalloys. In LFW, the rapid increase in temperature, at the contact surfaces, locally reduces the deformation resistance of the workpiece materials that then plastically deform under the applied forging forces and form a solid-state bond. In the case of dissimilar material joints, plastic deformation occurs preferentially from the workpiece with lower strength (or deformation resistance) at the elevated temperatures experienced during LFW.

### BRIEF DESCRIPTION OF THE DRAWINGS

The drawings included herewith are for illustrating various examples of apparatuses and methods of the present disclosure and are not intended to limit the scope of what is taught in any way.

FIG. 1 shows microstructures of materials, namely (a) and (b) tool steel, and (c) and (d) shovel tooth steel, using optical microscopy and scanning electron microscopy (SEM), respectively.

FIG. 2 shows schematic views of (a) shovel tooth steel and tool steel coupons, as well as their dimensions and configuration for linear friction welding (LFW) with a thermal camera, (b) dissimilar material joint and extraction of transverse weld cross-section, (c) extraction of tensile specimens from the weld, and (d) subsize tensile specimen geometry.

FIG. 3 shows front and isometric views of LFW weld between a shovel tooth and tool steel, high-frequency condition.

FIG. 4 shows SEM micrographs taken along an entire interface (along Plane A in FIG. 2(b)) of high-frequency LFW between dissimilar materials tool steel and a shovel tooth steel.

FIG. 5 shows SEM micrographs taken at the interface (along Plane A in FIG. 2(b)) for low-frequency condition, where the arrow demarcated in (c) highlights a crack that originated at the flash surface and extended into the tool steel.

FIG. 6 shows an SEM micrograph of a crack propagation path through the matrix of the tool steel of the low-frequency weld.

FIG. 7 shows a hardness profile for the low-frequency (LF) and high-frequency (HF) welded conditions as a function of distance.

FIG. 8 shows an optical micrograph of the medium pressure (MP) weld condition.

FIG. 9 shows a hardness profile for the low pressure (LP), MP, and high pressure (HP) welded conditions as a function of distance.

FIG. 10 shows an optical micrograph of the L6 (interlayer) weld condition.

### DETAILED DESCRIPTION

Various apparatuses or methods will be described below to provide an example of an embodiment of each claimed invention. No embodiment described below limits any claimed invention and any claimed invention may cover apparatuses and methods that differ from those described below. The claimed inventions are not limited to apparatuses and methods having all of the features of any one apparatus or method described below, or to features common to multiple or all of the apparatuses or methods described below. It is possible that an apparatus or method described below is not an embodiment of any claimed invention. Any invention disclosed in an apparatus or method described below that is not claimed in this document may be the subject matter of another protective instrument, for example, a continuing patent application, and the applicant(s), inventor(s) and/or owner(s) do not intend to abandon, disclaim or dedicate to the public any such invention by its disclosure in this document.

The teachings described herein relate to methods of linear friction welding (LFW) for joining of dissimilar materials, and composite assemblies produced therefrom. The teachings can be used to join a high wear resistant material to a base material for mining wear applications. In particular, the present disclosure demonstrates joining a tool steel (CPM 15V) to a ground engaging tools (GET) material (a cast alloyed carbon steel) using LFW, and weld integrity is studied by examining the characteristics and properties of the joints.

Developing the LFW methods to bond this combination of dissimilar materials can be advantageous for several reasons. Firstly, as the capacity of LFW systems can limit only the joint surface area and not the workpiece thickness, there can be no limitation to the layer thickness of the wear-resistant material applied to the GET materials. Furthermore, LFW has capability for near-net shape joining of complex cross-sectional profiles, rendering flexibility for bonding the wear-resistant material to different GET shapes, sizes and materials. Moreover, localized and relatively lower temperatures during LFW has potential to minimize changes to the assembled geometry, microstructure, and properties, such that bonding of the wear-resistant materials to the GET materials may be possible after heat treating these materials separately. In particular, the wear resistant portion and the base body can be heat treated separately before joining to achieve optimum wear resistance and mechanical properties, respectively.

Accordingly, in an aspect of the present disclosure, a method of joining a high wear resistant material to a base material can include providing a first workpiece formed of the high wear resistant material, and providing a second workpiece formed of the base material. A compressive force is applied between the first and second workpieces, and a friction force is generated between the first and second workpieces. A solid-state joint is formed between the first and second workpieces.

In some examples, the method can include linearly oscillating one of the workpieces to generate the friction force. In LFW, one part is held in a fixed position while the other reciprocates linearly. Once frictional heating softens the interfaces, the reciprocating action can be stopped and a forging force can be applied to join the two parts. Compared to rotary or orbital friction welding, LFW has the capability for near-net shape joining of complex cross-sectional profiles. In some examples, the method can include applying the compressive force in an axial direction that is generally orthogonal to a linear direction of oscillation. A forge actuator can be used with one workpiece to apply the compressive force. An in-plane actuator can be used with the other workpiece to provide oscillating motion.

Frequency is an important parameter of LFW. In some examples, the method can include oscillating the second workpiece at a frequency of between 20 and 110 Hz. Various frequencies can be used including, but not limited to, 20 Hz, 40 Hz, 60 Hz, 80 Hz, 100 Hz, and 110 Hz. A high-frequency can be effective to locally heat, plasticize and bond the dissimilar materials. However, LFW with high-frequencies can be difficult and/or costly to perform. The inventors have obtained good results oscillating the second workpiece at a frequency of about 110 Hz with the materials discussed herein.

Another important parameter of LFW is amplitude. In some examples, the method can include oscillating the second workpiece with an amplitude of between 0.5 and 2.5 mm. Various amplitudes can be used including, but not limited to, 0.5 mm, 1.0 mm, 1.5 mm, 2.0 mm, and 2.5 mm. With a large amplitude greater than 2.0 mm, the exposed overlapping surfaces can oxidize at elevated temperatures. At smaller amplitudes of less than 0.5 mm, the flash may not extrude well. Therefore, there is a balance in selecting an appropriate amplitude. The inventors have obtained good results oscillating the second workpiece with an amplitude of about 2.0 mm with the materials discussed herein.

Pressure is a further important parameter of LFW. The pressure depends on the compressive force and the cross section of the workpieces. The pressure can be controlled and varied throughout the phases of LFW. Various pressure values can be used including, but not limited to, 40 MPa, 60 MPa, 90 MPa, 150 MPa, 180 MPa, 300 MPa, 330 MPa, and 360 MPa. A high pressure can be effective to locally heat, plasticize and bond the dissimilar materials. The inventors have obtained good results oscillating the second workpiece at a frequency of 110 Hz and a pressure of 300 MPa with the materials discussed herein.

In a first, contact phase of LFW, there is contact between the first and second workpieces, wearing of surface asperities, and some small axial shortening. In some examples, in the first phase, the compressive force can result in a friction pressure of about 40 MPa between the first and second workpieces.

Next, in a second, transition phase, the compressive and friction forces cause a rapid increase in temperature and a plasticized layer is formed between the first and second workpieces. This stage is about plasticity. The materials at the interface soften as they heat up, and displacement indicates plastic deformation.

In a third, burn-off phase, the plasticized interface material is expelled as flash resulting in axial shortening of the workpieces. In some examples, in the third phase, the compressive force can result in a burn-off pressure of between 40 and 360 MPa between the first and second workpieces. Optionally, the burn-off pressure can be increased during the third phase, or maintained at a steady state. The third phase can continue until a time threshold and/or displacement threshold are met, but displacement can give better control. For example, the third phase can continue until an axial shortening of 2.0 mm is recorded.

Next, in a fourth, forge phase, oscillation stops to cease the frictional heating, and the compressive force can result in a forge pressure of between 40 and 360 MPa between the first and second workpieces. Optionally, the forge pressure can be increased during the fourth phase, or maintained at a steady state.

In some examples, the high wear resistant material can consist of a tool steel, which can be selected from CPM 1V, CPM 3V, CPM 9V, CPM 10V, and CPM 15V. The base material can consist of a low alloy steel or a carbon steel. Before LFW, the first and second workpieces can be heat treated separately to obtain good properties.

In some examples, the resulting solid-state joint between the first and second workpieces can have an ultimate tensile strength of greater than about 100 MPa. In some examples, the joint can have an ultimate tensile strength of greater than about 1200 MPa.

In some examples, an interlayer can be applied to one of the workpieces prior to forming the joint. The interlayer can be formed of any material which is compositionally compatible between the metals of the workpieces. In some examples, Ni or Ni-base alloys such as Ni—Cr have been found to be effective. The interlayer can be applied by welding, coating, or deposition techniques. In some examples, electroplating, electroless plating, additive manufacturing, weld bead deposition, cladding, laser cladding, arc welding, chemical vapor depositing, physical vapor deposition, thermal spraying, cold spraying, or vacuum melting could be used.

A composite assembly can be formed according to methods of the present disclosure. Such a composite assembly can include a workpiece formed of a high wear resistant material, a workpiece formed of a base material, and a solid-state joint formed between those two workpieces. The solid-state joint can be formed by linear friction welding.

Other aspects and features of the present disclosure will become apparent upon review of the following sections of the description, which are intended to be illustrative but non-limiting.

### Experimental Procedures

As mentioned above, the two materials selected for solid-state joining using LFW were a cast low alloy carbon steel, extracted from a commercial shovel tooth part, as well as CPM 15V tool steel, fabricated using a combined powder metallurgy production process and a subsequent standard mill processing (the Crucible Particle Metallurgy (CPM® process) and supplied by Crucible Industries (Solvay, NY, USA). Their chemical compositions are given in Table 1.

TABLE 1
Chemical compositions (wt. %) of the steels joined by LFW

| Steel | C | Mn | Si | Cr | Mo | V | S | Fe |
|---|---|---|---|---|---|---|---|---|
| Shovel | 0.258 | 1.14 | 1.48 | 2.11 | 0.23 | 0.005 | 0.008 | Balance |
| tooth | | | | | | | | |
| CPM | 3.40 | 0.50 | 0.90 | 5.25 | 1.30 | 14.50 | 0.07 | Balance |
| 15V | | | | | | | | |

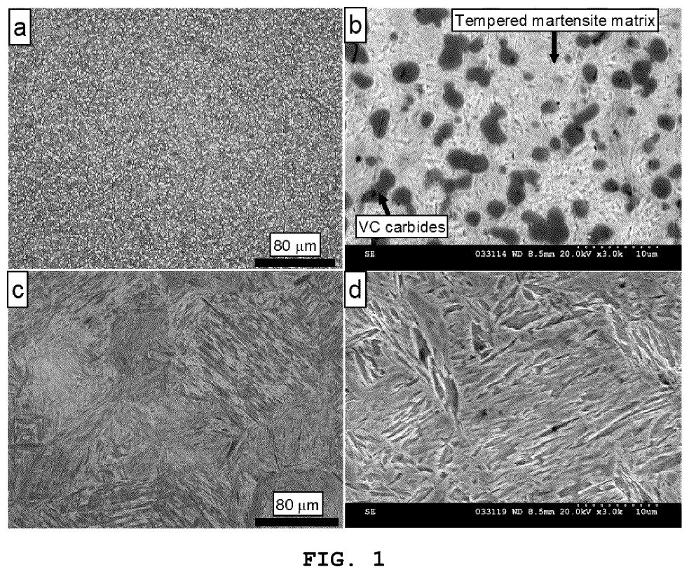

The cast shovel tooth steel was quench-and-temper heat treated according to industrial practice and had a hardness of 53±2 HRC. By contrast, the CPM 15V tool steel was heat treated for high wear resistance using a multi-step procedure that involved (1) austenitizing to realize adequate dissolution of the alloying elements, (2) hardening to maximize the wear resistance and (3) tempering to improve/balance the toughness. The austenitizing solution treatment consisted of heating the CPM 15V tool steel in a laboratory furnace to 1150° C. and holding for 30 minutes. The CPM 15V tool steel was then cooled to room temperature by forced air quenching. Immediately afterwards, the CPM 15V tool steel material was subjected to triple tempering and each individual tempering stage consisted of heating to 555° C., holding at temperature for 120 minutes, followed by forced air quenching to room temperature. After heat treatment, the hardness of the CPM 15V tool steel was 63±2 HRC. The microstructures of the CPM 15V tool steel and the shovel tooth steel are shown in FIGS. 1(a)-(b) and (c)-(d), respectively. The microstructure of the shovel tooth material was predominately tempered martensite, which is important in manufacturing practice for balancing the combination of properties (e.g., hardness and toughness) required for its industrial application. The microstructure of the CPM 15V steel consisted of a matrix of tempered martensite with uniformly dispersed spherical vanadium carbides (VC), roughly ˜3 μm in diameter.

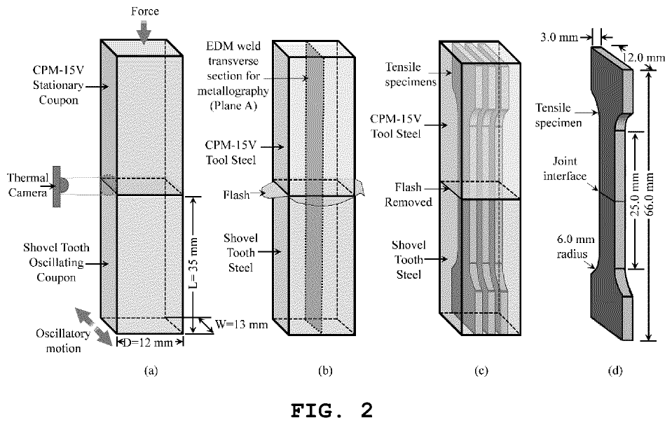

The coupons of the shovel tooth steel and CPM 15V tool steel were electro-discharge machined (EDM) to dimensions of 12.0 mm (D) by 13.0 mm (W) by 33.0 mm (L) with a tolerance of 0.02 mm. In preparation for LFW, the faying surfaces of the coupons were lightly sanded at the joint interface using 320-grit sandpaper and then cleaned with ethanol just before placing them into the LFW coupon holder. The equipment used for LFW was an MTS LFW process development system (PDS) at the National Research Council Canada's Aerospace Manufacturing Technology Center (Montreal, Quebec, Canada). The MTS LFW PDS system consists of two hydraulic actuators and—with the chosen configuration illustrated in FIG. 2(a)—the shovel tooth steel coupon was placed in the lower holder that was oscillated by the in-plane actuator, while the CPM 15V tool steel coupon was held stationary in the top holder to which the forge actuator applied a downward load. While FIG. 2(a) depicts the coupons as being oscillated along the transverse axis any axis of oscillation which is orthogonal to the downward load could be used. Further tests revealed that swapping the workpiece configuration does not affect the joining quality (or mechanical properties of the joint).

While various devices and equipment could be used, Tables 2 and 3 show the main set parameters used for the LFW joining by the inventors. To gain insight into the effect of these parameters on the joining performance between the CPM tool steel and the low-carbon steel, each joint was assessed using tensile tests, microhardness profile measurements, recordings of the surface temperature at the joint interface, and SEM micrographs.

TABLE 2
LFW specifications

| Components | Specification | Maximum |
|---|---|---|
| Forge actuator | | |
| Forge load (kN) | 60 | 90 |
| Displacement (mm) | ±6 | ±6 |
| In-plane actuator | | |
| Friction force (kN) | 50 | 50 |
| Displacement (mm) | ±10 | ±10 |
| Amplitude range (mm) | ±0.2 to ±5 | ±5 |
| Frequency range (Hz) | 15 to 100 | 125 |
| Hade axis | | |
| Side force (kN) | 15 | 15 |
| Weld time (s) | <10 | 10 |

There are two types of tests in Table 3 in terms of process parameters; those performed under high-frequency and those performed under low-frequency. It is shown that those joints produced under the high-frequency conditions produced reliable and optimized joining between the CPM 15V tool steel and the low-carbon steel by avoiding crack initiation/propagation at the interface and limiting the heat-affected zone. Therefore, the high-frequency conditions enhanced the mechanical properties of the joint more than the low-frequency condition. Some additional experimental data points were obtained beyond the frequency of 110 HZ, but no additional benefits were observed by using those higher frequencies.

TABLE 3
LFW parameters used to join CPM 15V
steel and the low-carbon steel

| | | Friction | Burn-off | Forge | |
|---|---|---|---|---|---|
| | Frequency | pressure | pressure | pressure | Amplitude |
| ID | (Hz) | (MPa) | (MPa) | (MPa) | (mm) |
| — | 100 | 40 | 150 | 150 | 0.5 |
| — | 100 | 40 | 150 | 150 | 1 |
| — | 100 | 40 | 90 | 90 | 0.5 |
| — | 100 | 40 | 90 | 90 | 1 |
| High- | 100 | 40 | 90 | 90 | 2 |
| frequency | | | | | |
| — | 100 | 40 | 40 | 40 | 0.5 |
| — | 100 | 40 | 40 | 40 | 1 |
| — | 100 | 40 | 40 | 40 | 2.5 |
| — | 40 | 40 | 90 | 90 | 2 |
| — | 20 | 40 | 90 | 90 | 2 |
| Low- | 20 | 40 | 40 | 40 | 2 |
| frequency | | | | | |
| — | 20 | 40 | 60 | 60 | 2 |

The LFW experiments were conducted in air (without any gas shielding protection) at a room temperature of 22° C. To capture the evolution in the surface temperature at the joint interface during LFW, measurements were made using a FLIR SC8300HD thermal camera (Wilsonville, OR, USA). To assure the accuracy of the surface temperature measurements, the thermal camera used was blackbody calibrated to NIST traceability. However, having calibrated the thermal camera on a blackbody source (or perfect radiator), the ability to measure the temperature on the interface of the shovel tooth steel and CPM 15V joint depends directly on the actual surface emissivity within the LFW process temperature range. Thus, to determine the average emissivity value, the methodology involved heating the shovel tooth steel and CPM 15V tool steel coupons to 1100° C. in a furnace and monitoring their actual temperatures using a thermocouple attached to their surfaces. Then, the surface temperatures on the shovel tooth steel and CPM 15V tool steel coupons were also measured with the thermal camera. The emissivity was adjusted by matching the surface temperature measurements from the thermal camera to that of the contact thermocouple during cooling from 1100° C. to 550° C. This resulted in an average emissivity of 0.9.

After LFW, transverse sections were extracted from the welds using EDM, as illustrated schematically in FIG. 2(b). Metallographic preparation of the transverse weld cross-sections (i.e. on Plane A in FIG. 2(b)) involved automated grinding using successively finer SiC papers from 220-grit to 1200-grit and water to render the surface planar and with a 9 μm finish. Then the specimens were polished sequentially on a Struers MD-Dur, MD-Dac and MD-Nap pads (Ballerup, Denmark) using respectively 6 μm, 3 μm and 1 μm diamond suspensions with DP-blue lubricant. The microstructural characteristics of the welds were examined on a polished surface using secondary electron (SE) imaging at an accelerating voltage of 20 kV on a Hitachi S 3500 N variable pressure scanning electron microscope (SEM) (Etobicoke, Ontario, Canada). This microscope was also equipped with an energy-dispersive X-ray spectroscopy (EDS) detector for elemental analysis/mapping.

To prepare the welds for micro-hardness testing, the joints were cold-mounted in resin and mechanically polished to a 1 μm finish using the automated grinding and polishing procedure described above. Vickers micro-hardness testing was guided by ASTM E 384-17 and performed using a Struers DuraScan 80 machine (Ballerup, Denmark) equipped with an automated x-y stage and a fully automated testing cycle (i.e. stage movement, loading, focusing, and measurement). Specifically, at least 3 hardness profiles were carried out on transverse weld cross-sections (i.e. Plane A in FIG. 2(b)) at an interval of 0.1 mm with a load of 200 g for a dwell period of 15 seconds. The minimum test point separation distance for all measurements was at least three times the diagonal measurement of the indent to avoid any potential effect of strain fields from the neighboring indents.

On the basis of ASTM E8M-16a standard as a guide for tensile testing, tensile specimens having a standard sub-size geometry of 25 mm in gage length, 6 mm in width, and 3 mm in thickness were extracted (FIG. 2(c)) and machined (FIG. 2(d)) from the joints. The tensile specimens for each joint were tested at room temperature using a 250 kN MTS testing frame integrated with a laser extensometer and a non-contact optical 3D deformation measurement system (often referred to as digital image correlation), Aramis®.

Prior to tensile loading, one side of the tensile specimen was marked with two pieces of retro-reflective tape to define the gage length for the laser extensometer measurements during testing. On the opposite side, the tensile specimen surface was first painted with a white background and then a high-contrast random pattern of black speckles was applied. As the functionality of the Aramis® digital image correlation (DIC) system is sensitive to the quality of this speckle pattern, verification of pattern recognition was performed before tensile testing to ensure proper strain recording along the entire gage length. Tensile tests were conducted until rupture using displacement control at a rate of 0.4 mm/min, which corresponds to an average strain rate of 0.015 min⁻¹. To obtain the global stress-strain curves and related mechanical properties, the load data collected from the tensile testing machine was used to calculate the engineering stresses during the test, while the related strains were calculated from the displacement obtained from the laser extensometer. A minimum of three tensile specimens for each selected weld condition were tested to calculate the average properties. The mechanical properties evaluated included the ultimate tensile strength (UTS), percent elongation (EL) and elastic modulus (E) obtained from the stress-strain curve of each tensile specimen. Also, the deformation captured by the Aramis® system was used to map the 2D strain distribution along the gage length of each tensile specimen. From the strain distribution maps captured using DIC, the strain localization just prior to rupture was examined. After testing, the tensile fracture surfaces were observed using stereo-microscopy and SE imaging at 20 keV by SEM.

### Results and Discussion

### Thermal Conditions and Macroscopic Inspection

The temperature readings that were taken with the thermal camera during LFW of the CPM 15V tool steel to the shovel-tooth steel were analyzed for the two conditions (low-frequency and high-frequency) at the onset of the forging stage, so as to extract temperature distribution maps. As discussed above, the LFW process can be divided into four distinct phases: (1) the initial or contact phase, (2) transition or conditioning phase, (3) equilibrium or burn-off phase, and (4) forge phase. Examining the core area in the temperature distribution maps, in the low-frequency condition, the maximum surface temperature in the core area did not exceed values above ˜890° C., and the temperature distribution area was relatively narrow, both along and across the interface. By contrast, for the high-frequency condition, the maximum temperature at the interface surface was about 1000° C. and the temperature distribution—both along and across the interface—was more uniform and broader relative to the low-frequency condition. Surrounding these core areas of maximum temperatures, lower temperature isotherms were also apparent for both the low-frequency and high-frequency conditions.

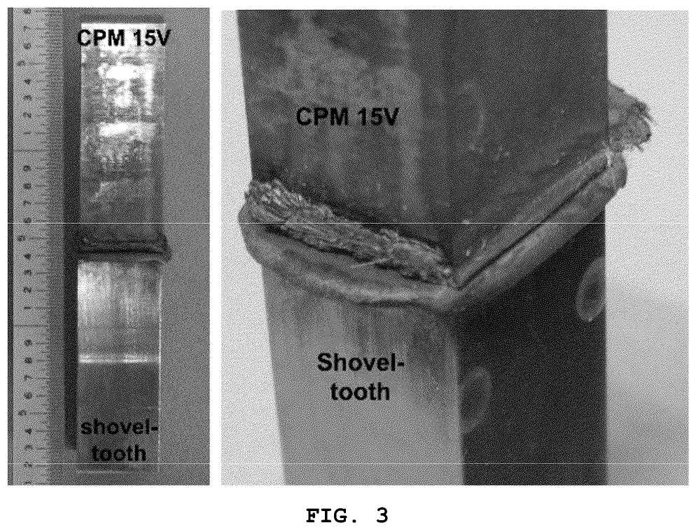

As LFW is a solid-state joining technology, the maximum temperatures reached during processing are lower than the melting point of the materials. The LFW process is also self-regulated by the change in the material properties—that takes place in the materials as friction heating occurs—and the four phases of the weld cycle that must be present to achieve bonding at the interface, using an appropriate selection of pre-set parameters/conditions. During LFW of the CPM 15V tool steel to the shovel tooth steel, the applied low-frequency and high-frequency conditions resulted in temperatures at the joint surface that exceeded the tempering conditions for both materials. This, in turn, led to localized softening of both materials, but considering the strength/hardness differences of the two materials, preferential plasticization and extrusion of the shovel tooth steel occurred relative to CPM 15V steel, as illustrated in FIG. 3 for the high-frequency linear friction weld.

### Microscopic Examination

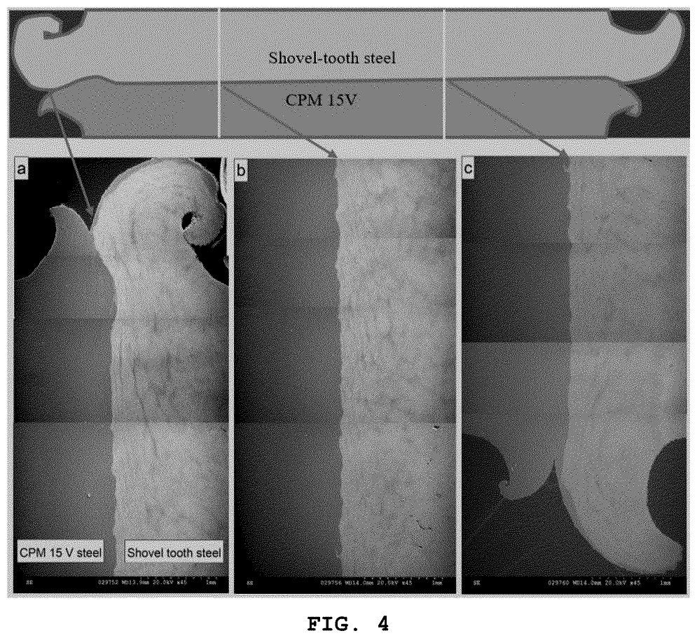

Microscopic evaluation of the welds between the CPM 15V and shovel tooth steel materials was undertaken on Plane A (as defined in FIG. 2(b)) and the characteristics of the joint interface were examined using SEM. At low magnification, the wavy boundary or weld interface between the CPM 15V and shovel tooth steel materials was evident, as illustrated in FIG. 4 for the high-frequency weld condition. This continuous and wavy joint interface that formed between the CPM 15V and shovel tooth steels appeared well-bonded without any noticeable defects, such as cracks, pores/voids or delamination. The asymmetry of the flash layers at the edges of the joint was also apparent and points to the disparate extrusion of the plastically deformed material from the shovel tooth and CPM 15 V steels during LFW. The micro-pores noticeable in FIG. 4(b), roughly 1 mm from the joint interface in the shovel tooth steel microstructure, are defects that already existed in the alloyed carbon steel casting, likely generated during the casting process and not related to the welding process itself.

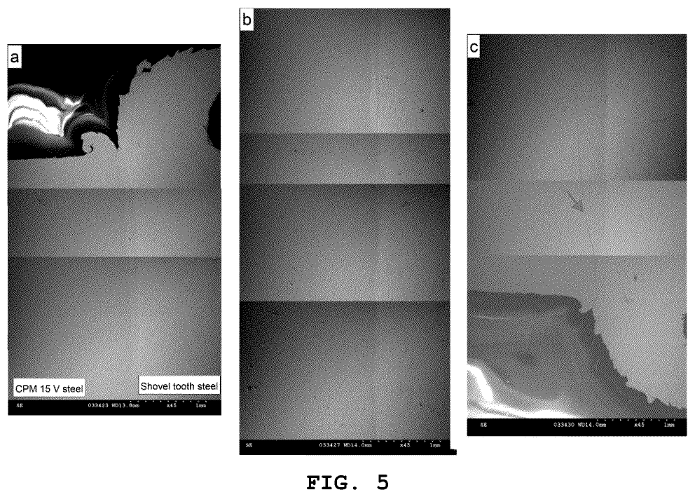

A similar examination conducted using SEM on the low-frequency weld, as shown in FIG. 5, presented comparable findings of a continuous joint interface (though less wavy) between the CPM 15V and the shovel tooth steels without any noticeable defects, except for a single crack originating at one edge from the CPM 15V flash surface (FIG. 5(c)) and extending inwards into the CPM 15V tool steel. Under the low-frequency condition, the plastically deformed flash layers, mainly from the shovel tooth steel, also exhibited surface ripples or ridges that, indicate a stepwise extrusion from the oscillatory motion during the LFW process. The absence of these ripples/ridges on the plastically deformed flash layers of the high-frequency weld intimate more uniform extrusion conditions, which may be related to the higher maximum temperatures relative to that experienced by the low-frequency joint. With increasing temperature, the flow stress of steels can decrease. Similar trends have been observed in other alloy systems such as Fe—Mn—Al—C and Fe—Mn—Si steels under hot compression conditions. Thus, the lower temperatures (and thus higher flow stress) of the shovel tooth steel during LFW under the low-frequency condition hindered plastic deformation and flash expulsion, which, in turn, rendered a high potential for cracking that was exacerbated by the temperature gradients across the interface and the inherent brittleness of the CPM 15V material. The crack in the low-frequency weld circumvented the joint interface and propagated through the CPM 15V, in a direction parallel to, and at a distance of up to 400 μm from the interface. This region can be related to the heat affected zone (HAZ) on the CPM 15V side where the thermal gradients during LFW result in the formation of retransformed (untempered) martensite.

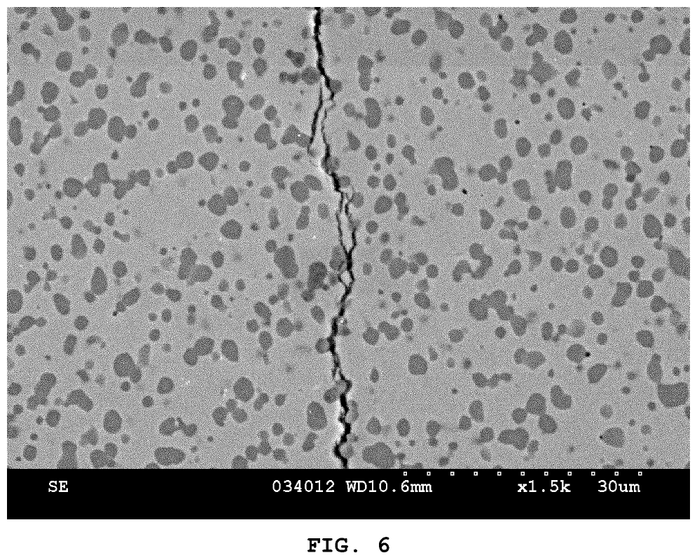

Imaging at higher magnifications permitted resolving the metallurgical transformations occurring in the plastically affected zone (PAZ) and/or HAZ on either side of the joint interface between the CPM 15V and shovel-tooth steels. Microstructures in the low-frequency weld have similar characteristics. Apart from the joint interface/boundary that appeared to be intimately bonded metallurgically, in the PAZ/HAZ, certain intermixed regions, confined close to the interface, were present. Elemental mapping in these regions at the interface, using EDS, revealed a stark contrast of the main compositional elements—Fe, Cr and V—at the weld line, which is indicative of the absence of long-range diffusion across the initial interface between the CPM 15V and shovel-tooth steels, at least at this micro-scale level investigated. This may be attributed to the limited atomic diffusion and element partitioning possible during LFW due to the very short durations at the elevated temperatures. Nonetheless, under the thermal conditions experienced by the low-frequency and high-frequency welds, two main transformations occurred: (1) dissolution/fragmentation of the spherical VC and (2) formation of retransformed (untempered) martensite. Specifically, on the CPM 15V tool steel side, VC dissolution/fragmentation was noticeable, as indicated by the presence of non-uniformly sized smaller particles or their complete absence, especially in the intermixed regions close to the joint interface. Complete dissolution of VC in low carbon steels (in face centered cubic (f.c.c) state) can take place at temperatures as low as ˜900° C. Hence, taking into account the temperature range achieved during low-frequency and high-frequency conditions, it is reasonable to assume that partial dissolution of VC took place. Additionally, fragmentation of VC is another feasible mechanism to explain the observed VC breakdown in the intermixed region—mainly due to the high strain rates and pressures during LFW that induce enormous shear and normal forces onto the VC particles and lead to their fragmentation. On the other hand, the intermixed regions also consisted of pockets of retransformed martensite—i.e. the tempered martensite in the microstructure of the shovel-tooth steel and the CPM 15V matrix that transformed to austenite on heating during LFW and then reverted back to martensite (untempered) on cooling after welding. This formation of retransformed martensite was also observed in the PAZ/HAZ on both sides of the joint interface. To this end, close examination of the crack in the HAZ of the low-frequency weld (FIG. 6) revealed that the preferred propagation path was through the CPM 15V matrix, consisting most likely of retransformed martensite (considering the hardness as discussed in the next section). Also, evident from FIG. 6 is the change in the propagation path of the crack when in the proximity of the VC particles that also clearly points to fracture occurring through the CPM 15V matrix.

### Microhardness

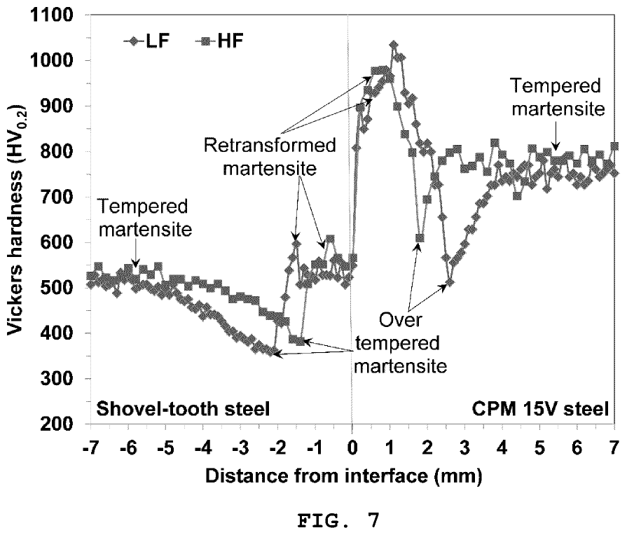

The Vickers microhardness profiles across the joint interface (distance=0 mm) in the dissimilar material welds between the CPM 15V tool steel and the shovel tooth steel are shown in FIG. 7 for the low-frequency and high-frequency conditions. The hardness of the tempered martensite microstructure on the shovel tooth steel side remained nearly constant at ˜500 HV_{0.2} up to roughly −5.0 mm from joint interface, at which point gradual softening commenced, more rapidly for the low-frequency weld relative to the high-frequency weld. This softening can be attributed to over-tempering of the martensitic microstructure and hardness minima of ˜380 HV_{0.2} and ˜360 HV_{0.2} were respectively measured for the high-frequency and low-frequency conditions at distances of −1.4 mm and −2.2 mm respectively from the joint interface. From these minimum hardness values, a sharp rise in the hardness to ˜600 HV_{0.2} was observed for both the low-frequency and high-frequency conditions. This may be attributed to the formation of retransformed martensite in the microstructure of the PAZ just adjacent to the joint interface on the shovel tooth side. Specifically, the high frictional/thermal heat generated on heating during LFW transforms the martensite to austenite in the PAZ of the shovel tooth steel and, on rapid cooling after LFW, the austenite reverts to (retransformed) martensite. As this retransformed martensite is untempered, its hardness is higher than that of the tempered martensite microstructure of the shovel tooth steel base material. The average hardness in the PAZ was about 550 HV_{0.2} for both the low-frequency and high-frequency welds, and this region remained nearly constant up to the joint interface at 0 mm, which delimited the end of the microstructural changes on the shovel tooth steel side.

On the CPM 15V tool steel side, there was a similar trend in the microhardness evolution as a function of distance from the joint interface. From 0 mm to ˜1 mm, there was a sharp increase in the hardness to a peak value of ˜980 HV_{0.2} and ˜1030 HV_{0.2} in the HAZ on the CPM 15V steel side of the high-frequency and low-frequency welds, respectively. This region of maximum hardness in the low-frequency and high-frequency welds can be related again to the formation of retransformed martensite in the matrix microstructure of the CPM 15V tool steel due to the high local thermal gradients, as described above for the PAZ on the shovel tooth steel side. Then, the hardness decreased sharply to minimum values of ˜610 HV_{0.2} and ˜510 HV_{0.2} that were located at respective distances of ˜1.8 mm and ˜2.6 mm from the joint interface in the high-frequency and low-frequency welds, respectively. This region of minimum hardness in both the high-frequency and low-frequency welds is likely related to the over-tempered condition of the tempered martensite microstructure of the CPM 15V tool steel base material. From these minima on the CPM 15V steel side, the hardness increased gradually in both the low-frequency and high-frequency welds (though more rapidly in the latter) to a value of ˜780 HV_{0.2}, which corresponds to hardness of the tempered martensite microstructure in the unaffected CPM 15V base material.

From the hardness profiles across the joint interface between the CPM 15V and shovel tooth steels, the width of the PAZ and/or HAZ can be measured to understand the extent of heat transfer in the low-frequency and high-frequency welds. The width of the PAZ/HAZ is delimited, for both the low-frequency and high-frequency conditions, by the initial hardness values of the unaffected base materials—tempered CPM 15V tool steel (780 HV_{0.2}) and tempered shovel tooth steel (500 HV_{0.2}). Thus, for the low-frequency condition, changes in hardness on the shovel tooth steel side were seen to start at −5.0 mm and endured until 4.0 mm on the CPM 15V steel side, giving a width of 9.0 mm for PAZ/HAZ. By contrast, for the high-frequency condition, the width of the PAZ was narrower, starting at −3.6 mm on the shovel tooth side and continuing until 2.4 mm on the CPM 15V tool steel side, with a total width of 6.0 mm. This effect of higher frequency on reducing the size of the thermo-mechanically affected region has been reported for LFW of other materials, such as titanium alloy Ti-6Al-4V and nickel-base superalloy, Waspaloy, and linked to the material extrusion characteristics during LFW. LFW using high-frequency was seen here to improve material yielding and preferential extruding of the shovel tooth steel, which in turn, confined the size of the PAZ/HAZ closer to the joint interface and gave a width reduction of about 33% relative to low-frequency condition. The peak-to-valley hardness difference was also about 12% lower for the high-frequency condition (597 HV_{0.2}) relative to the low-frequency condition (675 HV_{0.2}), and as hardness gradients can lead to strain localization along the joint interface, the use of low-frequency during LFW predisposes the dissimilar material weld to a higher sensitivity to cracking relative to the high-frequency setting.

### Tensile Properties

The average room temperature tensile properties of the dissimilar material joints between the CPM 15V and shovel tooth steels are listed in Table 4 for the low-frequency and high-frequency conditions. The statistical significance is based on three repetitions per condition. The ultimate tensile strength (UTS), ductility (elongation, EL) and elastic modulus (E) were the lowest for the low-frequency weld with values of 138.0 MPa for the UTS, 0.1% for the EL and 155.4 GPa for the E, respectively. By contrast, the UTS of the high-frequency weld (552.9 MPa) was 4 times greater and the modulus (227.6 GPa) was about 32% higher than the low-frequency weld. For the high-frequency condition, the joint efficiency—defined here as the ratio of the strength of the weld to the strength of the unaffected shovel tooth steel base material—was calculated to be about 35%. But the elastic modulus of high-frequency weld was at least statistically comparable to the shovel tooth base material and that of the CPM 15V tool steel. Considering the challenges faced for assembly of these dissimilar steels, these tensile properties obtained for the high-frequency condition are promising for the LFW process, as typically this weld combination may be unweldable by conventional technologies and may tend to separate without applying any force due to the inherent disparate properties of the CPM 15V and shovel tooth steels.

TABLE 4
Average tensile properties of the low-
frequency and high-frequency welds

| Condition | UTS (MPa) | EL (%) | E (GPa) |
|---|---|---|---|
| Low- | 138.0 ± 32.7 | 0.1 ± 0.0 | 155.4 ± 25.0 |
| frequency | 552.9 ± 29.2 | | |
| High- | | 0.2 ± 0.0 | 227.6 ± 21.8 |
| frequency | | | |
| Shovel tooth | 1583.6 ± 77.8 | 4.8 ± 2.4 | 219.92 ± 33.8 |
| CPM-15V | NA | NA | 235 GPa |

NA = not available/applicable

To gain further insight on the deformation response of the low-frequency and high-frequency welds, DIC techniques were applied during static tensile loading to understand the strain response and distribution. For the low-frequency weld, the map of the strain distribution just before fracture showed strain localization around the joint and early fracture initiated from this region of maximum strain (of locally 0.14%) at the interface between the CPM 15V and shovel-tooth steels. As the resistance to the loading/deformation of the low-frequency weld was insufficient, the other regions of the gage length—comprising the CPM 15V and shovel-tooth steels—showed comparatively smaller strains (0.02-0.05). By contrast, the strain distribution in the high-frequency weld was more even within the gage region of the tensile specimen. Locally, the strains were higher on the shovel-tooth steel side (˜0.3%) relative to the CPM 15V tool steel side (˜0.18), which is explicable on the basis of their disparate properties (e.g., hardness and stiffness). Also, in the absence of strain localization in the vicinity of the joint, final fracture occurred in the high-frequency weld at comparatively higher loads/stresses (4 times greater than the low-frequency condition), albeit still at the interface. Nonetheless, this was relatively good resistance to loading/deformation for the high-frequency weld.

### Fracture Surfaces

After tensile testing, the fracture surfaces of the low-frequency and high-frequency welds were examined using stereomicroscopy, SEM and EDS. Under stereomicroscopy, several regions with two main characteristics were visible: matte areas and reflective or shiny regions. On the fracture surface of the low-frequency weld, the relative fraction of reflective areas was greater than that on the high-frequency weld. As well, the morphology of the reflective regions on the fracture surfaces was different between the low-frequency weld fracture (irregular) and that of the high-frequency weld (vertical bands perpendicular to the oscillation direction). Typically, the appearance of shiny/reflective fracture surfaces are indicators of very little plastic deformation and brittle fracture mechanisms.

Examination of these areas using SEM with EDS elemental mapping on the fracture surfaces of the low-frequency and high-frequency welds gave different findings. Specifically, vanadium was observed to be evenly distributed over the entire fracture surface of the low-frequency weld, which suggests exposure of the CPM 15V surface and is understandable considering the poor bonding between the CPM 15V and shovel-tooth steels that was seen to result in cracking through the HAZ of the CPM 15V steel (FIG. 5). By contrast, for the high-frequency weld, only the narrow and dark vertical bands on the fractured surfaces were rich in vanadium and chromium, which points to a mixed fracture path, both through the shovel-tooth steel (where intermixing/bonding with the CPM 15V led to a higher load resistance of the joint) and CPM 15V steel (in regions that were not sufficiently bonded).

### Effect of Forging Pressure on Linear Friction Weldability

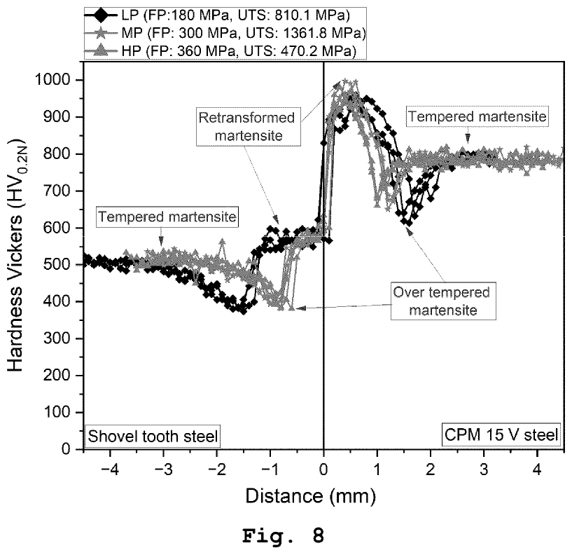

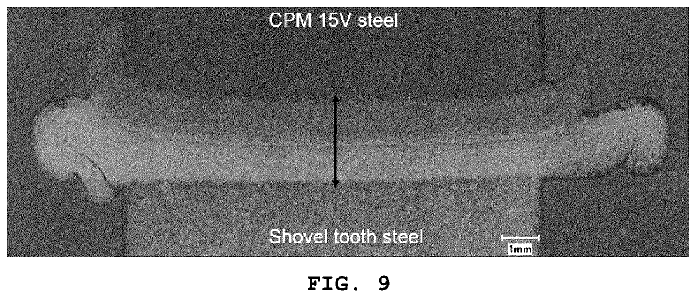

The effect of frequency is discussed above. To demonstrate the role of forging pressure (FP) on the joint strength, frequency values were kept constant at 110 HZ while the FP was varied from 90 MPa to 360 MPa using the parameters shown in Table 5. The effect of FP in the localized heat generation is similar to that of frequency, that is, by increasing the FP the heat-affected zone is reduced as can be observed in FIG. 8 (inferred from the distance from the stable tempered martensites). Nonetheless, in this case, having the smallest affected zone area by increasing the FP does not necessarily produce the best joint strength as can be seen in Table 6. Rather, there is an optimum FP value that corresponds to 300 MPa (MP condition in Table 6) where the strongest joint strength was achieved among all the conditions explored as can be observed in FIG. 9 (no cracks were observed). It is also noteworthy that the metallurgical transformations across the joint as indicated in FIG. 8 are similar to those described and discussed above through the examination of the effect of frequency.

TABLE 5
LFW parameters used to join CPM 15V steel and the low-
carbon steel to study the effect of forging pressure

| | | Friction | Burn-off | Forge | |
|---|---|---|---|---|---|
| | Frequency | pressure | pressure | pressure | Amplitude |
| ID | (Hz) | (MPa) | (MPa) | (MPa) | (mm) |
| — | 110 | 40 | 90 | 90 | 2 |
| — | 110 | 40 | 90 | 90 | 2.5 |
| LP | 110 | 40 | 180 | 180 | 2 |
| MP | 110 | 40 | 300 | 300 | 2 |
| — | 110 | 40 | 330 | 330 | 2 |
| HP | 110 | 40 | 360 | 360 | 2 |

TABLE 6
Tensile properties of the low-pressure (LP), medium-pressure
(MP), and high-pressure (HP) welding conditions

| Condition | UTS (MPa) | EL (%) | E (GPa) |
|---|---|---|---|
| LP | 810.1 | 0.2 | 326 |
| MP | 1223 | 0.4 | 282 |
| HP | 470.2 | 0.2 | 185 |
| Shovel tooth | 1583.6 ± 77.8 | 4.8 ± 2.4 | 219.92 ± 33.8 |
| CPM-15V | NA | NA | 235 GPa |

### Effect of Interlayer on Linear Friction Weldability

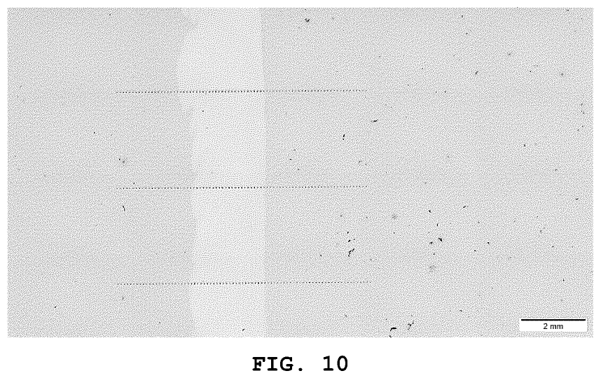

An interlayer between the two workpieces can be useful either to increase the joint strength and ductility or to enable manufacturing of the joints using lower process parameters. To assess the role of interlayers on the joint strength, a Ni-base alloy interlayer was deposited on the CPM surface, followed by LFW using the process parameters shown in Table 7. The maximum strength of the L5 and L6 conditions were comparable to the high-frequency condition, but with a key benefit of an improved operating space/window for processing. For instance, the L6 condition enabled the manufacturing of a linear friction welded joint with reasonably good mechanical properties at considerably lower processing parameters (frequency and pressure), which potentially reduces the requirements for a linear friction welding machine. FIG. 10 shows an optical micrograph image of the L6 joint condition, where no crack or other defects are observed.

TABLE 7
LFW parameters used to join CPM 15V steel and the
low-carbon steel to study the effect of interlayer

| | | Friction | Burn-off | Forge | |
|---|---|---|---|---|---|
| | Frequency | pressure | pressure | pressure | Amplitude |
| ID | (Hz) | (MPa) | (MPa) | (MPa) | (mm) |
| L1 | 40 | 40 | 90 | 90 | 2 |
| L2 | 100 | 40 | 90 | 90 | 2 |
| L3 | 110 | 40 | 90 | 90 | 2 |
| L4 | 110 | 40 | 180 | 180 | 2 |
| L5 | 110 | 40 | 300 | 300 | 2 |
| L6 | 70 | 40 | 90 | 90 | 2 |

TABLE 8
Tensile properties of the joints using Ni-base alloy interlayers

| Condition | UTS (MPa) | EL (%) | E (GPa) |
|---|---|---|---|
| L1 | 364.1 | 0.3 | 114 |
| L2 | 271.5 | 0.1 | 184 |
| L3 | 325.7 | 0.5 | 239 |
| L4 | 97.3 | 0.1 | 97.9 |
| L5 | 669.0 | 0.4 | 210.5 |
| L6 | 566.5 | 0.3 | 216.8 |

### CONCLUSIONS

The present disclosure demonstrates the joining of dissimilar materials CPM 15V tool steel and a low-carbon alloyed steel (extracted from a shovel tooth) using linear friction welding (LFW) for wear applications.

Three conditions of interest are presented in detail for LFW of the CPM 15V tool steel to the shovel tooth steel, namely those performed under high-frequency and low-frequency conditions, those performed under high-pressure (HP) and low-pressure (LP) conditions, and those using a Ni-base alloy interlayer. Here it was demonstrated the key roles of controlling frequency, forging pressure, and the use of the interlayer on the mechanical properties and microstructure of the joint. In summary, high frequencies and/or medium forging pressures tend to form a continuous joint interface without the presence of discontinuities, such as pores, voids, and/or cracks at the joint interface which produced high mechanical properties for the joints. The use of Ni-base alloy interlayer enables high mechanical properties by using relatively low process parameters, which enhances the audience of this invention by allowing the use of linear friction processing at lower costs (e.g., capital).

A distinct interface remained at the initial joint interface between the CPM 15V tool steel and the shovel tooth steel, indicating that long-range ordering on diffusion during LFW was insignificant across the interface due to the short times at elevated temperatures that limited element diffusion (as verified using energy X-ray dispersive mapping) and partitioning.

The thermal history during LFW resulted in two main transformations in the HAZ and/or plastically affected zone (PAZ) of the low-frequency, high-frequency and MF-HP welds: dissolution/fragmentation of vanadium carbides on the CPM 15V side and formation of retransformed martensite on the shovel tooth side as well as in the matrix on the CPM 15V tool steel side. These transformations affected the hardness in PAZ/HAZ, with softening and hardening occurring on both sides of the joint interface due to over-tempering of the tempered martensite microstructure of the base materials and formation of retransformed (untempered) martensite, respectively.

The tensile strength and ductility of the dissimilar material joints were higher for high-frequency condition relative to the low-frequency condition and highest for the MP condition. Strain mapping using digital image correlation during tensile loading revealed rapid strain localization around the joint interface for the low-frequency weld, whereas the strain distribution was relatively even in the high-frequency weld.

The fractured surfaces of the high-frequency weld showed a higher fraction of matte areas exhibiting dimple rupture features relative to the low-frequency weld that consisted of more shiny (reflective) areas, which were related to brittle areas.

Manufacturing of joints between dissimilar materials CPM 15V tool steel and a shovel tooth steel using LFW was shown to be feasible and the properties are amenable for wear applications.

While the above description provides examples of one or more apparatuses or methods, it will be appreciated that other apparatuses or methods may be within the scope of the accompanying claims.

We claim:

1. A method of joining a high wear resistant material to a base material, comprising:
providing a first workpiece formed of the high wear resistant material;
providing a second workpiece formed of the base material;
applying a compressive force between the first and second workpieces;
generating a friction force between the first and second workpieces; and
forming a solid-state joint between the first and second workpieces.

2. The method of claim 1, comprising linearly oscillating at least one of the first and second workpieces to generate the friction force.

3. The method of claim 1, comprising applying the compressive force in an axial direction that is generally orthogonal to a linear direction of oscillation.

4. The method of claim 1, comprising, in a contact phase, wearing of surface asperities between the first and second workpieces, and wherein the compressive force results in a friction pressure of 40 MPa between the first and second workpieces.

5. The method of claim 1, comprising, in a transition phase, causing a rapid increase in temperature and forming a plasticized layer between the first and second workpieces.

6. The method of claim 1, comprising, in a burn-off phase, expelling upset and axially shortening the first and second workpieces, and wherein the compressive force results in a burn-off pressure of between 40 and 360 MPa between the first and second workpieces.

7. The method of claim 1, comprising, in a forge phase, stopping generating the friction force, and wherein the compressive force results in a forge pressure of between 40 and 360 MPa between the first and second workpieces.

8. The method of claim 1, wherein the high wear resistant material consists of a tool steel.

9. The method of claim 1, wherein the base material consists of a low alloy steel or a carbon steel.

10. The method of claim 1, wherein the joint has an ultimate tensile strength of greater than 100 MPa.

11. The method of claim 1, comprising, prior to the steps of applying, heat treating at least one of the first and second workpieces.

12. The method of claim 1, comprising applying an interlayer on the base material prior to forming the joint.

13. The method of claim 12, wherein the interlayer is formed of Ni or Ni-base alloy.

14. The method of claim 12, wherein the step of applying the interlayer comprises at least one of electroplating, electroless plating, additive manufacturing, weld bead deposition, cladding, laser cladding, arc welding, chemical vapor depositing, physical vapor deposition, thermal spraying, cold spraying, and vacuum melting.

15. A composite assembly, comprising:
a first workpiece formed of a high wear resistant material,
a second workpiece formed of a base material; and
a solid-state joint formed between the first and second workpieces.

16. The composite assembly of claim 15, wherein the solid-state joint is formed by at least one of linear friction welding, orbital friction welding, and rotary friction welding.

17. The composite assembly of claim 15, wherein the high wear resistant material consists of a tool steel.

18. The composite assembly of claim 15, wherein the base material consists of a low alloy steel or a carbon steel.

19. The composite assembly of claim 15, wherein the joint has an ultimate tensile strength of greater than 100 MPa.

20. The composite assembly of claim 15, comprising an interlayer applied between the base material and the joint.

21. The composite assembly of claim 20, wherein the interlayer is formed of Ni or Ni-base alloy.
